(19) United States
(12) Patent Application Publication
(10) Pub. No.: US 2025/0138241 A1
(43) Pub. Date: May 1, 2025

(54) GRATING ANTENNA

(71) Applicant: SILITH TECHNOLOGY PTE. LTD., SINGAPORE (SG)

(72) Inventors: Guangzhu ZHOU, Shanghai (CN); Shuxin WANG, Shanghai (CN)

(73) Assignee: SILITH TECHNOLOGY PTE. LTD., SINGAPORE (SG)

(21) Appl. No.: 18/921,004

(22) Filed: Oct. 21, 2024

(30) Foreign Application Priority Data
Nov. 1, 2023 (CN) 202311432881.X

(51) Int. Cl. G02B 6/124; G02F 1/295; H01Q 5/22

(52) U.S. Cl. CPC G02B 6/124; G02F 1/295; H01Q 5/22

(57) ABSTRACT

A grating antenna includes a waveguide, a plurality of groove structures, arranged inwards on a surface of the waveguide and periodically along a light transmission direction; a plurality of grating structures, arranged outwards on two sides of the waveguide, symmetrically and periodically in the light transmission direction; a period size of the groove structures is consistent with a period size of the grating structures, the groove structures and the grating structures have a certain relative displacement offset in the light transmission direction, and an intensity of a first radiation light field generated by the groove structures is substantively equal to that of a second radiation light field generated by the grating structures. According to the disclosure, a high-efficiency unidirectional radiation characteristic of the grating antenna in a free-space can be realized, and a radiation efficiency of the grating antenna does not oscillate along with wavelength in a target wavelength domain.

### CROSS-REFERENCE TO RELATED APPLICATION

This application claims the priority benefit of China application serial no. 202311432881.X, filed on Nov. 1, 2023. The entirety of the above-mentioned patent application is hereby incorporated by reference herein and made a part of this specification.

### BACKGROUND

### Technical Field

The present disclosure relates to the technical field of photonic integrated circuit processes, in particular to a grating antenna having high-efficiency and unidirectional radiation.

### Description of Related Art

A grating antenna is an important basic unit for coupling a field of guided waves to a free-space radiation field and a mode field of an optical fiber in a waveguide of a photonic integrated circuit (PIC), the grating antenna is usually formed by a periodic modulation on an upper surface or a side wall of the waveguide. However, in a conventional silicon-on-insulator (SOI) structure, due to lack of a bottom plate, a light field leaked periodically from the waveguide will radiate towards a free-space side and a bottom base side simultaneously, resulting in a radiation efficiency relatively low at the free-space side. For a grating antenna in a waveguide without a special design, the radiation efficiency at the free-space side is typically less than 50%. Therefore, on basis of a mature SOI platform and processing condition, how to design a grating antenna to achieve a high radiation efficiency at the free-space side, that is, a unidirectional radiation, is a technical problem to be solved in the prior art.

Generally, it is possible to improve the radiation efficiency by designing a plurality of shallow etched grating on a waveguide structure, however, it can only achieve a relatively limited effect. A high-efficiency grating antenna in the prior art is mainly adopting a multi-layer grating structure, and it is required to design a waveguide structure on each layer according to a requirement. Wherein for a solution adopting the shallow etched grating, a defect thereof is: the radiation efficiency is improved limitedly, and due to an interference effect between a plurality of reflected waves at an interface in the bottom base, an antenna efficiency oscillates following a wavelength variation; for a solution of adopting a grating with a multi-layer structure, a defect thereof is: it requires to customize a wafer structure, causing a complicated process and having a problem of alignment between the multi-layer structures.

### SUMMARY

An objective of the present disclosure is providing a grating antenna, in order to overcome a plurality of above-mentioned defects in the prior art.

In order to achieve the objective stated above, the technical solution of the present disclosure is as follows:
the present disclosure provides a grating antenna, comprising:
a waveguide;
a plurality of groove structures, arranged inwards on a surface of the waveguide and periodically along a light transmission direction;
a plurality of grating structures, arranged outwards on two side surfaces of the waveguide, symmetrically and periodically along the light transmission direction;
a period size of the plurality of groove structures is consistent with a period size of the plurality of grating structures, the plurality of groove structures and the plurality of grating structures have a certain relative displacement offset in the light transmission direction, and an intensity of a first radiation light field generated by the plurality of groove structures is substantively equal to an intensity of a second radiation light field generated by the plurality of grating structures.

Further, the plurality of groove structures, relative to the plurality of grating structures, has a displacement offset ahead along a direction facing to the light transmission.

Further, a center of each of the plurality of groove structures, relative to a center of each of the plurality of grating structures, has a displacement offset ahead along a direction facing to the light transmission.

Further, the waveguide comprises a strip-shaped waveguide; a shape of each of the plurality of groove structures comprises a rectangle, a square, a circle, and an ellipse; and/or, a shape of each of the plurality of grating structure comprises a rectangle, a square, a circle, and an ellipse.

Further, a depth of each of the plurality of groove structures in the waveguide is less than or equal to a height of the waveguide in a same direction; and/or a height of each of the plurality of grating structures is less than or equal to the height of the waveguide in a same direction, and a bottom surface of the plurality of grating structures is on a same level of a bottom surface of the waveguide.

Further, the grating antenna is wrapped in a cladding layer made of dielectric, and the cladding layer made of dielectric is arranged on a surface of a substrate.

Further, a material of the grating antenna comprises silicon, silicon nitride, silicon oxynitride, lithium niobate, indium phosphide, aluminum oxide, or a polymer; and/or a refractive index of the material is higher than a refractive index of a material of the cladding layer.

Further, the grating antenna is arranged on a Silicon-On-Insulator (SOI) substrate, the SOI substrate has a handle layer, a Buried Oxide (BOX) layer and a device layer arranged sequentially, the grating antenna is formed by the device layer, the BOX layer forms a lower cladding layer of the grating antenna, and a surface of the BOX layer has an upper cladding layer arranged on, the upper cladding layer covers the grating antenna, and forms a cladding layer wrapping the grating antenna together with the BOX layer acting as the lower cladding layer.

Further, by controlling a projection size of each of the plurality of groove structures and a projection size of each of the plurality of grating structures on a plane where a surface of the waveguide locates, the intensity of the first radiation light field generated by the plurality of groove structures is substantively equal to the intensity of the second radiation light field generated by the plurality of grating structures.

Further, the waveguide has a width of 0.4 μm and a height of 0.22 μm; each of the plurality of groove structures has a length of 0.13 μm, a width of 0.13 μm, and a depth of 70 nm; each of the plurality of grating structures arranged on either side has a length of 0.375 μm, a width of 0.2 μm, and a height of 70 nm; a period size of the plurality of groove structures and a period size of the plurality of grating structures are both 750 nm, and a relative displacement offset between each of the plurality of groove structures and each of the plurality of grating structures is 200 nm; and a length of the grating antenna is 20 μm.

It can be seen that, by arranging the plurality of groove structures periodically along the light transmission direction on the surface of the waveguide, and arranging the plurality of grating structures periodically and symmetrically along the light transmission direction on two side surfaces of the waveguide, further by arranging the period size of the plurality of groove structures consistent with the periodic size of the plurality of grating structures, and arranging each of the plurality of groove structures and each of the plurality of grating structures to have a certain relative displacement offset along the light transmission direction, as well as arranging the intensity of the first radiation light field generated by the plurality of groove structures close to the intensity of the second radiation light field generated by the plurality of grating structures, it is possible to generate a destructive interference to a third radiation light field on the bottom base, while generating a constructive interference to a fourth radiation light field on an upper half space, thus the grating antenna achieves a unidirectional radiation characteristic with a high efficiency, that is, greater than 95%, in a free-space. Further, since there is almost no light field leaked to the bottom base, the radiation efficiency of the grating antenna will not oscillate with the wavelength in the target wavelength domain, that is, 1500-1600 nm. Furthermore, the grating antenna is possible to be fabricated by using a conventional SOI structure and a standard tape-out process, instead of requiring a multi-layer structure to achieve a similar functionality, thereby a process is simplified. Therefore, the present disclosure has solved effectively a plurality of problems in the prior art including a conventional grating antenna having a low radiation efficiency at the free-space side, the efficiency of the grating antenna oscillating with the wavelength, and the grating antenna having a multi-layer structure and a complicated process.

### BRIEF DESCRIPTION OF THE DRAWINGS

FIG. 1 illustrates a schematic plan view on a grating antenna according to a preferred embodiment of the present disclosure;

FIG. 2 illustrates a schematic cross-sectional view on a grating antenna according to a preferred embodiment of the present disclosure;

FIG. 3 illustrates a schematic diagram on an electric field distribution when a grating antenna is working, according to a preferred embodiment of the present disclosure; wherein, a horizontal axis and a vertical axis correspond to an X-axis and a Z-axis of a rectangular coordinate system respectively, while a coordinate unit is μm.

### DESCRIPTION OF THE EMBODIMENTS

In order to make the objectives, technical solutions, and advantages of the embodiments of the present disclosure clearer, the technical solutions in the embodiments of the present disclosure are described below clearly and completely. All other embodiments obtained by a person of ordinary skill in the art based on the embodiments of the present disclosure without creative efforts shall fall within the protection scope of the present disclosure. Unless otherwise defined, technical or scientific terms used herein have the same meanings as commonly understood by one of ordinary skill in the art to which the present disclosure belongs. The words “including” and the like used herein mean that elements or objects in front of the word encompass the elements or objects listed after the word and their equivalents, instead of excluding other elements or objects.

A plurality of specific embodiments of the present disclosure are further described in details below, with reference to the accompanying drawings.

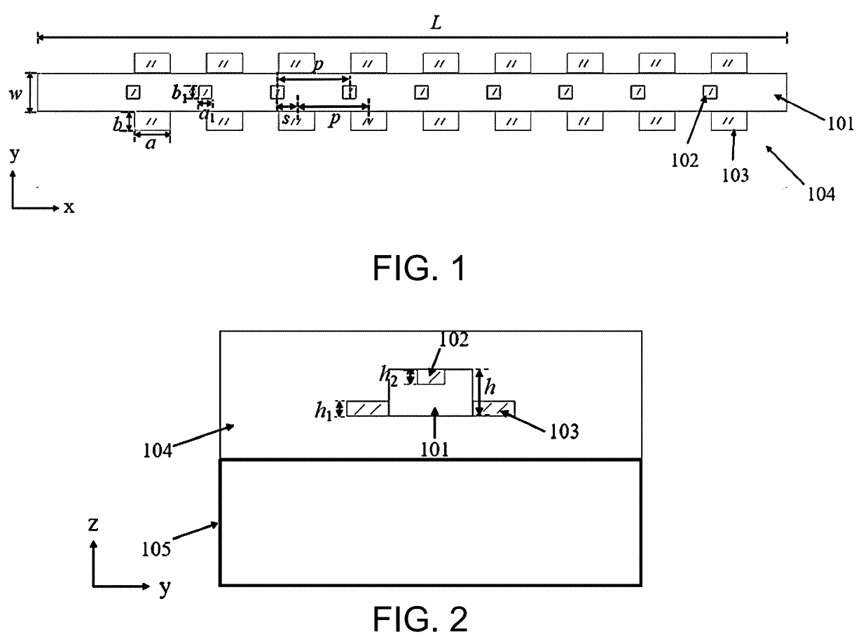

Referencing to FIG. 1, the present disclosure discloses a grating antenna, comprising: a waveguide 101; a plurality of groove structures 102, and a plurality of grating structures 103.

Wherein the plurality of groove structures 102 are arranged on a surface of the waveguide 101, that is, the surface of the waveguide 101 facing to a drawing surface as shown in FIG. 1, and going inside the waveguide 101. Along a light transmission direction, such as an X-axis direction of a spatial rectangular coordinate system shown as FIG. 1, that is, in a direction from a left end to a right end of the waveguide 101, the plurality of groove structures 102 are arranged periodically at a uniform distance on the surface of the waveguide 101. Further, a connection line between a center of each of the plurality of groove structures 102 is parallel to an axis of the waveguide 101 in the light transmission direction, and a projection of the connection line between the center of each of the plurality of groove structure 102 on the surface of the waveguide 101 shown in FIG. 1 coincides with a projection of an axis of the waveguide 101 along the light transmission direction on the surface of the waveguide 101. The plurality of groove structures 102 form a side wall of a closed groove on the surface of the waveguide 101, that is, a projection of each of all the plurality of groove structures 102 on the surface of the waveguide 101 is located in an area within the surface of the waveguide 101.

The plurality of grating structures 103 are arranged in two groups, and each of the two groups of grating structures 103 comprises a plurality of grating structures 103 in a same quantity, and the two groups of grating structures 103 are arranged respectively on a side surface of the waveguide 101 along the axis of the waveguide 101 in the light transmission direction, the two groups of grating structures 103 are arranged respectively on two side surfaces of the waveguide 101 in a Y-axis direction of the spatial rectangular coordinate system shown as FIG. 1, and arranged in a direction facing away the side surfaces of the waveguide 101. each grating structure 103 in the two groups of grating structures 103 are arranged symmetrically and periodically at an interval on the two side surfaces of the waveguide 101, that is, the grating structures 103 in the two groups of grating structures 103 are arranged in pairs on two sides of the waveguide 101, and any two pairs of adjacent grating structures 103 have a same interval. The plurality of grating structures 103 are connected to the side surface of the waveguide 101 and integrated with the waveguide 101. An amount of the plurality of groove structures 102 is corresponding to an amount of pairs of the plurality of grating structures 103.

A length L of the grating antenna in the light transmission direction may be arranged according to a design requirement, while an amount of the plurality of groove structures 102 and an amount of the plurality of grating structures 103 shown in FIG. 1 are merely an embodiment, instead of limiting the amount of the plurality of groove structures 102 and the amount of the plurality of grating structures 103.

A distance between two centers of each two adjacent groove structures 102 forms a period size of the plurality of groove structures 102; the distance between two centers of every two adjacent grating structures 103 in each group of grating structures 103, that is, a distance between the centers of every two pairs of adjacent grating structures 103, forms the period size of the plurality of grating structures 103. The period size of the plurality of groove structure 102 is consistent with the period size of the plurality of grating structure 103, and a same period P is used to indicate that the two have a same period size.

Further, each of the plurality of groove structures 102 and each of the plurality of grating structures 103 have a certain relative displacement offset S along the light transmission direction, that is, between each of the plurality of groove structures 102 and each of the plurality of grating structures 103 correspondingly, that is, a pair of grating structures 103, a relative position in the light transmission direction has a certain front-back dislocation.

The grating antenna disclosed by the present disclosure, when light enters the waveguide 101 and transmits from a left end of the waveguide 101 to a right end of the waveguide 101, shown as FIG. 1, an intensity of a first radiation light field generated when the light is transmitting inside the plurality of groove structures 102 is close or consistent to an intensity of a second radiation light field generated when the light is transmitting inside the plurality of grating structures 103.

Referring to FIG. 1, in a plurality of embodiments, the plurality of groove structures 102, relative to the plurality of grating structures 103, have a certain displacement offset S in a direction facing to the light transmission, that is, in a direction towards the left end of the waveguide 101.

Further, a center of each of the plurality of groove structures 102, relative to a center of each of the plurality of grating structures 103, have a displacement offset ahead along a direction facing to the light transmission.

In a plurality of embodiments, the waveguide 101 comprises a strip-shaped waveguide 101, shown as FIG. 1, extending in a direction from left to right.

In a plurality of embodiments, a planer shape of each of the plurality of groove structures distributed periodically on the surface of the waveguide 101 acting as a center of the grating antenna, comprises a rectangle, a square, a circle, and an ellipse, with a size variable.

In a plurality of embodiments, a planer shape of each of the plurality of grating structure distributed periodically on the two side surfaces of the waveguide 101 in the center, comprises a rectangle, a square, a circle, and an ellipse, with a size variable.

Referencing to FIG. 2 and FIG. 1, FIG. 2 can be considered as a cross-sectional profile of the grating antenna formed by cutting the waveguide 101 following the Y-axis direction at a place of any one of the plurality of groove structures 102 in FIG. 1. In a plurality of embodiments, a depth H₂ of each of the plurality of groove structures 102 in the waveguide 101, that is, a height of the plurality of groove structures 102 in the Z-axis direction of the spatial rectangular coordinate system shown in FIG. 2 is less than or equal to a height H of the waveguide 101 in a same direction, wherein FIG. 2 and FIG. 1 are based on a same spatial rectangular coordinate system.

In a plurality of embodiments, a height H₁ of each of the plurality of grating structures 103 is less than or equal to the height H of the waveguide 101 in a same direction, and a bottom surface of the plurality of grating structures 103, that is, a bottom surface shown in FIG. 2, is on a same level of a bottom surface of the waveguide 101.

In a plurality of embodiments, the grating antenna is wrapped in a cladding layer 104 made of a dielectric, and the cladding layer 104 is arranged on a surface of a substrate 105. The cladding layer 104 further forms a complete filling to the plurality of groove structures 102, and a complete filling to a plurality of voids between the plurality of grating structures 103.

In a plurality of embodiments, the waveguide 101 and the plurality of grating structures are made of a same material.

In a plurality of embodiments, a refractive index of a material of the grating antenna is higher than a refractive index of a material of the cladding layer 104 made of dielectric.

In a plurality of embodiments, the material of the grating antenna comprises silicon, silicon nitride, silicon oxynitride, lithium niobate, indium phosphide, aluminum oxide, or a polymer. The material of the cladding layer 104 made of dielectric is silicon dioxide. The substrate 105 is a silicon substrate.

In a plurality of embodiments, the plurality of grating antennas are arranged on an SOI substrate; and the SOI substrate has a handle layer, a Buried Oxide (BOX) layer and a device layer arranged sequentially, acting as a silicon substrate. The grating antenna, the waveguide 101, the plurality of groove structures 102, or the plurality of grating structures 103 is manufactured by the device layer, the BOX layer forms a lower cladding layer of the grating antenna, and a surface of the BOX layer has an upper cladding layer arranged on, the upper cladding layer covers the grating antenna, and forms a cladding layer 104 wrapping the grating antenna together with the BOX layer acting as the lower cladding layer.

In a plurality of embodiments, by controlling a projection size of each of the plurality of groove structures 102 and a projection size of each of the plurality of grating structures 103 on a plane where a surface of the waveguide 101 locates, the intensity of the first radiation light field generated by the plurality of groove structures 102 is substantively equal to the intensity of the second radiation light field generated by the plurality of grating structures 103.

Referencing to FIG. 1 and FIG. 2, in an embodiment, the waveguide 101 is a strip-shaped silicon waveguide 101, the plurality of groove structures 102 and the plurality of grating structures 103 are rectangular shaped, the waveguide 101 has a length L along the X-axis direction, a width W along the Y-axis direction, and a height H along the Z-axis direction. The plurality of groove structures 102 has a length Aj along the X-axis direction, a width B₁ along the Y-axis direction, and a depth or height H₂ along the Z-axis direction. The grating structure 103 has a length A along the X-axis direction, a width B along the Y-axis direction, and a height H₁ along the Z-axis direction. The plurality of groove structures 102 and the plurality of grating structures 103 have a same period P. The grating antenna has a length L along the X-axis direction. Light enters the left end of the waveguide 101 from a left side shown in FIG. 1, and transmits to the right end along the waveguide 101, that is, the light is transmitting in the X-axis direction. The plurality of groove structures 102 in a period has a displacement offset S ahead of the plurality of grating structures 103 in a period along a direction facing to the light transmission.

The light transmits in the waveguide 101 at a center position, and first enters a region of the plurality of groove structures 102 distributed periodically; at this time, the first radiation light field radiates toward both sides of the free-space and the substrate 105. Then the light continues transmitting in the waveguide 101 before entering two sides having a region of the plurality of grating structures 103 distributed periodically, while in a same way, the plurality of grating structures 103 also radiate a second radiation light field to the free-space and the substrate 105. Controlling a plurality of values of above parameters A₁, B₁, A, and B, until the intensities of the two radiation light fields are close to each other. Since the plurality of groove structures 102 distributed periodically and the plurality of grating structures 103 distributed periodically have a certain displacement offset S in a guided wave direction, it is possible to generate a destructive interference to a radiation light field on a side of the substrate 105, while generating a constructive interference to a radiation light field on an upper half space, thus the grating antenna disclosed in the present disclosure achieves a unidirectional radiation characteristic with a high efficiency.

In a plurality of embodiments, the waveguide 101 operates in, such as a TE fundamental mode. The width W of the waveguide 101 is 0.4 μm, and the height H is 0.22 μm. The length A₁ of each of the plurality of groove structures 102 is 0.13 μm, the width B₁ thereof is 0.13 μm, and the depth H₂ thereof is 70 nm. The length A of the plurality of grating structures 103 on each side is 0.375 μm, the width B thereof is 0.2 μm, and the height H₁ thereof is 70 nm; the period size P of the plurality of groove structures 102 and the plurality of grating structures 103 is 750 nm, and the relative displacement offset S between the plurality of groove structures 102 and the plurality of grating structures 103 is 200 nm; and the length L of the grating antenna is 20 μm.

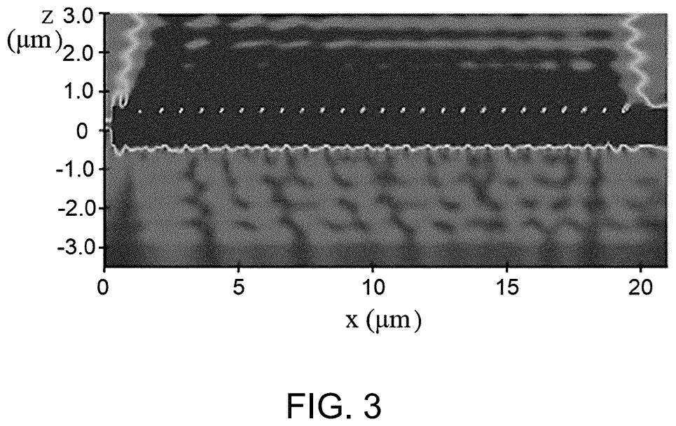

Referencing to FIG. 3, FIG. 3 illustrates a schematic diagram on an electric field distribution in an X-Z plane in the spatial rectangular coordinate system shown in FIG. 1 and FIG. 2, when an embodiment of the grating antenna disclosed in the present disclosure is working. Most of the light field radiated from the grating antenna interferes in the upper half-space and generates a free-space directional beam, while only very little energy is leaked to a lower substrate side, that is, the substrate 105, thus a unidirectional radiation characteristic with a high efficiency is well achieved, wherein a radiation efficiency at a wavelength of 1500 nm to the free-space side is greater than 95%, which is effective in a whole broadband range.

It is understandable that, the width W and a thickness, that is, the height H, of the waveguide 101 may be changed, as long as the waveguide 101 supports a single-mode operation. Further, an operation mode of a device of the grating antenna is not limited to TE, may also be TM.

The plurality of groove structures 102 distributed periodically along the surface of the waveguide 101 in the center may be formed by adopting a shallow etching, a deep etching, or a full etching.

The plurality of grating structures 103 distributed periodically along the two side surfaces of the waveguide 101 in the center may be formed by adopting a shallow etching, a deep etching, or a full etching.

The periods of the plurality of groove structures 102 distributed periodically and the plurality of grating structures 103 distributed periodically are equal to be P, and adjustable according to a requirements of a far-field radiation angle.

All above, by arranging the plurality of groove structures 102 periodically along the light transmission direction on the surface of the waveguide 101, and arranging the plurality of grating structures 103 periodically and symmetrically along the light transmission direction on two side surfaces of the waveguide 101, further by arranging the period size of the plurality of groove structures 102 consistent with the periodic size of the plurality of grating structures 103, and arranging each of the plurality of groove structures 102 and each of the plurality of grating structures 103 to have a certain relative displacement offset along the light transmission direction, as well as arranging the intensity of the radiation light field generated by the plurality of groove structures 102 close to the intensity of the radiation light field generated by the plurality of grating structures 103, it is possible to generate a destructive interference to a radiation light field on the bottom base, while generating a constructive interference to a radiation light field on an upper half space, thus the grating antenna achieves a unidirectional radiation characteristic with a high efficiency, which is greater than 95%, in a free-space. Further, since there is almost no light field leaked to the bottom base, the radiation efficiency of the grating antenna will not oscillate with the wavelength in the target wavelength domain, that is, 1500-1600 nm. Furthermore, the grating antenna is possible to be fabricated by using a conventional SOI structure and a standard tape-out process, instead of requiring a multi-layer structure to achieve a similar functionality, thereby a process is simplified. Therefore, the present disclosure has solved effectively a plurality of problems in the prior art including a conventional grating antenna having a low radiation efficiency at the free-space side, the efficiency of the grating antenna oscillating with the wavelength, and the grating antenna having a multi-layer structure and a complicated process.

While the embodiments of the present disclosure have been described in detail above, it will be apparent to those skilled in the art that various modifications and variations can be made to the embodiments. It should be understood, however, that such modifications and variations are within the scope and spirit of the present application as set forth in the claims. Moreover, the present application described herein is capable of other embodiments and of being practiced or of being carried out in various ways.

What is claimed is:

1. A grating antenna, comprising:
a waveguide;
a plurality of groove structures, arranged inwards on a surface of the waveguide and periodically along a light transmission direction; and
a plurality of grating structures, arranged outwards on two side surfaces of the waveguide, and arranged symmetrically and periodically along the light transmission direction,
wherein a period size of the plurality of groove structures is consistent with a period size of the plurality of grating structures, the plurality of groove structures and the plurality of grating structures have a displacement offset relative to each other in the light transmission direction, and an intensity of a first radiation light field generated by the plurality of groove structures is substantively equal to an intensity of a second radiation light field generated by the plurality of grating structures.

2. The grating antenna according to claim 1, wherein the plurality of groove structures, relative to the plurality of grating structures, have a displacement offset ahead along a direction facing to the light transmission.

3. The grating antenna according to claim 1, wherein a center of each of the plurality of groove structures, relative to a center of each of the plurality of grating structures, has a displacement offset ahead along a direction facing to the light transmission.

4. The grating antenna according to claim 1, wherein the waveguide comprises a strip-shaped waveguide; a shape of each of the plurality of groove structures comprises a rectangle, a square, a circle, and an ellipse; and/or, a shape of each of the plurality of grating structures comprises a rectangle, a square, a circle, and an ellipse.

5. The grating antenna according to claim 1, wherein a depth of each of the plurality of groove structures in the waveguide is less than or equal to a height of the waveguide in a same direction; and/or a height of each of the plurality of grating structures is less than or equal to a height of the waveguide in a same direction, and a bottom surface of the plurality of grating structures is on a same level of a bottom surface of the waveguide.

6. The grating antenna according to claim 1, wherein the grating antenna is wrapped in a cladding layer made of dielectric, and the cladding layer made of dielectric is arranged on a surface of a substrate.

7. The grating antenna according to claim 6, wherein a material of the grating antenna comprises silicon, silicon nitride, silicon oxynitride, lithium niobate, indium phosphide, aluminum oxide, or a polymer; and/or a refractive index of the material is higher than a refractive index of a material of the cladding layer.

8. The grating antenna according to claim 1, wherein the grating antenna is arranged on a Silicon-On-Insulator (SOI) substrate, the SOI substrate has a handle layer, a Buried Oxide (BOX) layer and a device layer arranged sequentially, the grating antenna is formed by the device layer, the BOX layer forms a lower cladding layer of the grating antenna, and a surface of the BOX layer has an upper cladding layer arranged thereon, the upper cladding layer covers the grating antenna, and forms a cladding layer wrapping the grating antenna together with the BOX layer acting as the lower cladding layer.

9. The grating antenna according to claim 1, wherein by controlling a projection size of each of the plurality of groove structures and a projection size of each of the plurality of grating structures on a plane where a surface of the waveguide locates, the intensity of the first radiation light field generated by the plurality of groove structures is substantively equal to the intensity of the second radiation light field generated by the plurality of grating structures.

10. The grating antenna according to claim 1, wherein the waveguide has a width of 0.4 μm and a height of 0.22 μm; each of the plurality of groove structures has a length of 0.13 μm, a width of 0.13 μm, and a depth of 70 nm; each of the plurality of grating structures arranged on either side has a length of 0.375 μm, a width of 0.2 μm, and a height of 70 nm; a period size of the plurality of groove structures and a period size of the plurality of grating structures are both 750 nm, and a relative displacement offset between each of the plurality of groove structures and each of the plurality of grating structures is 200 nm; and a length of the grating antenna is 20 μm.
